(19) United States
(12) Patent Application Publication
(10) Pub. No.: US 2021/0200813 A1
(43) Pub. Date: Jul. 1, 2021

(54) HUMAN-MACHINE INTERACTION METHOD, ELECTRONIC DEVICE, AND STORAGE MEDIUM

(71) Applicant: BEIJING BAIDU NETCOM SCIENCE AND TECHNOLOGY CO., LTD., Beijing (CN)

(72) Inventors: Jun Xu, Beijing (CN); Zeyang Lei, Beijing (CN); Zhengyu Niu, Beijing (CN); Hua Wu, Beijing (CN); Haifeng Wang, Beijing (CN)

(21) Appl. No.: 16/986,631

(22) Filed: Aug. 6, 2020

(30) Foreign Application Priority Data
Dec. 30, 2019 (CN) 201911403103.1

(51) Int. Cl. G06F 16/9032; G06F 16/903; G06F 40/35; G06F 16/901

(52) U.S. Cl. CPC G06F 16/90332; G06F 16/90344; G06F 16/9024; G06F 16/90328; G06F 40/35

(57) ABSTRACT

A human-machine interaction method is related to the field of artificial intelligence technologies. The method includes: obtaining a conversation sentence input by a user; obtaining a query sentence matching the conversation sentence; obtaining a plurality of associated query sentences corresponding to the query sentence based on a preset query word graph; processing the conversation sentence and the plurality of associated query sentences through a preset algorithm to select a target query sentence from the plurality of associated query sentences; and processing the target query sentence based on a preset response generation model to generate a response sentence for the user.

### CROSS-REFERENCE TO RELATED APPLICATION

This application claims priority to Chinese Patent Application No. 201911403103.1, filed on Dec. 30, 2019, the entire contents of which are incorporated herein by reference.

### FIELD

The disclosure relates to the field of artificial intelligence technologies in computer technologies, and more particularly, to a human-machine interaction method, an electronic device, and a storage medium.

### BACKGROUND

With the continuous development of artificial intelligence technologies, it is an increasingly common way of interaction in daily lives of users to converse with smart devices so as to meet needs of the users.

In the related art, response content in human-machine conversation may be not rich enough, and a conversation effect is relatively poor.

### SUMMARY

A first aspect of the disclosure provides a human-machine interaction method. The method includes: obtaining a conversation sentence input by a user; obtaining a query sentence matching the conversation sentence; obtaining a plurality of associated query sentences corresponding to the query sentence based on a preset query word graph; processing the conversation sentence and the plurality of associated query sentences through a preset algorithm to select a target query sentence from the plurality of associated query sentences; and processing the target query sentence based on a preset response generation model to generate a response sentence for the user.

A second aspect of the disclosure provides an electronic device. The electronic device includes at least one processor and a storage device communicatively connected to the at least one processor. The storage device stores an instruction executable by the at least one processor. When the instruction is executed by the at least one processor, the at least one processor is caused to execute the human-machine interaction method as described above.

A third aspect of the disclosure provides a non-transitory computer-readable storage medium having a computer instruction stored thereon. The computer instruction is configured to cause a computer to execute the human-machine interaction method as described above.

Other effects possessed by the above implementations will be described below in combination with specific embodiments.

### BRIEF DESCRIPTION OF THE DRAWINGS

The accompanying drawings are used for a better understanding of the solution of the disclosure, and do not constitute a limitation of the disclosure.

FIG. 1 is a flowchart of a human-machine interaction method according to an embodiment of the disclosure.

FIG. 2 is a schematic diagram of a query word graph according to an embodiment of the disclosure.

FIG. 3 is a flowchart of a human-machine interaction method according to an embodiment of the disclosure.

FIG. 4 is a block diagram of a human-machine interaction apparatus according to an embodiment of the disclosure.

FIG. 5 is a block diagram of a human-machine interaction apparatus according to an embodiment of the disclosure.

FIG. 6 is a block diagram of a human-machine interaction apparatus according to an embodiment of the disclosure.

FIG. 7 is a block diagram of an electronic device for implementing a human-machine interaction method according to embodiments of the disclosure.

### DETAILED DESCRIPTION

Exemplary embodiments of the disclosure will be described below with reference to the accompanying drawings, which may include various details of the embodiments of the disclosure to facilitate understanding, and should be considered as merely exemplary. Therefore, those skilled in the art should recognize that various changes and modifications may be made to the embodiments described herein without departing from the scope and spirit of the disclosure. Also, for clarity and conciseness, descriptions of well-known functions and structures are omitted in the following description.

A human-machine interaction method, a human-machine interaction apparatus, and an electronic device according to embodiments of the disclosure will be described below with reference to the accompanying drawings.

To solve technical problems of insufficient response content in human-machine conversation and an unsatisfying conversation effect, according to the solution, the conversation sentence input by the user is obtained. The query sentence matching the conversation sentence is obtained, and the plurality of associated query sentences corresponding to the query sentence is obtained based on the preset query word graph. The conversation sentence and the plurality of associated query sentences are processed through the preset algorithm to select the target query sentence from the plurality of associated query sentences. The target query sentence is processed based on the preset response generation model to generate the response sentence for the user. Consequently, a high-quality candidate list of response content is provided based on the relevance of query sentences in the query word graph, thereby providing rich content reflecting user interest.

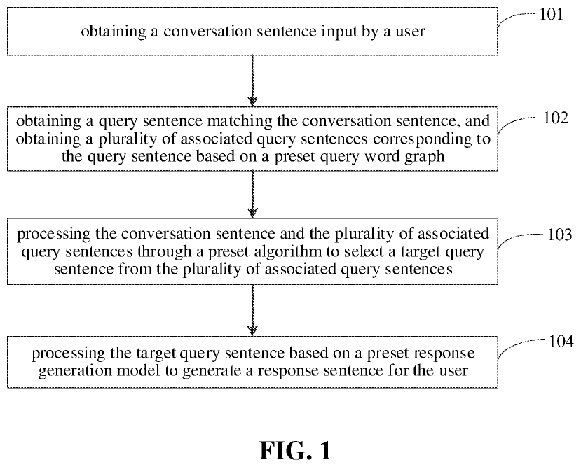

In detail, FIG. 1 is a flowchart of a human-machine interaction method according to an embodiment of the disclosure.

As illustrated in FIG. 1, the method includes the following.

At block 101, a conversation sentence input by a user is obtained.

At block 102, a query sentence matching the conversation sentence is obtained, and a plurality of associated query sentences corresponding to the query sentence is obtained based on a preset query word graph.

In practical applications, the user may interact with the smart device through text or by voice, so that the smart device may obtain the conversation sentence (that is, the chat conversation sentence) input by the user, such as “I heard that something happened to Boeing recently”, “Huawei P30 is good”, “I usually like to do yoga” and the like. The conversation sentence may be input based on personal characteristics, such as individual needs and expression habits, of users.

The query sentence matching the conversation sentence may be queried from a database, or the query sentence matching the conversation sentence may be searched for in a server, and the like. It should be noted that a corresponding sentence node of this query sentence may be found in the preset query word graph. When the conversation sentence is the same as the query sentence, it means that a corresponding sentence node of the conversation sentence may also be found in the preset query word graph.

As a result, the plurality of associated query sentences corresponding to the query sentence may be obtained based on the preset query word graph. It may be understood that relationships between the query sentence and the associated query sentences may be established based on search behavior logs of Internet users, so the relationships are most likely to be around a search intent or semantic topic. The preset query word graph may be established based on the correlation of the plurality of associated query sentences A, B and C, and the corresponding query sentence 1. Relevant data may be extracted directly from a plurality of search logs to analyze and establish the preset query word graph.

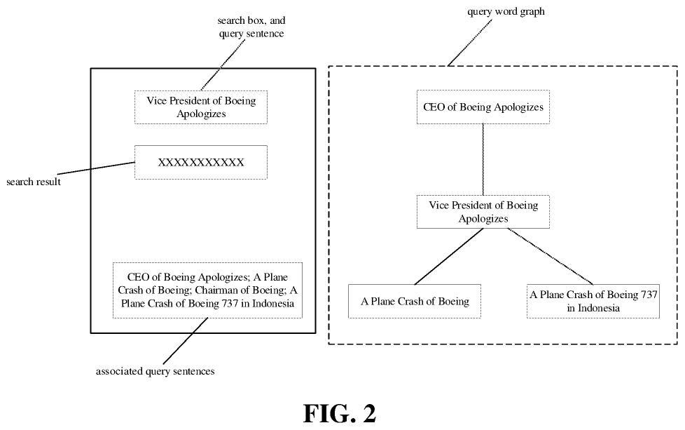

For example, as illustrated in FIG. 2, the conversation sentence is “I heard that something happened to Boeing recently”, and the matching query sentence is “Vice President of Boeing Apologizes”. A sentence node of the query sentence in the preset query word graph is “Vice President of Boeing Apologizes”, and a plurality of associated query sentences, such as “A Plane Crash of Boeing”, “CEO of Boeing Apologizes” and “A Plane Crash of Boeing 737 in Indonesia”, corresponding to the query sentence, may be obtained based on the preset query word graph through the sentence node “Vice President of Boeing Apologies”.

At block 103, the conversation sentence and the plurality of associated query sentences are processed through a preset algorithm, to select a target query sentence from the plurality of associated query sentences.

At block 104, the target query sentence is processed based on a preset response generation model to generate a response sentence for the user.

In detail, after obtaining the plurality of associated query sentences, the target query sentence may be determined from the plurality of associated query sentences, and the target query sentence is processed based on the preset response generation model to generate the response sentence for the user.

More specifically, the conversation sentence and the plurality of associated query sentences are processed through the preset algorithm. There are various ways of determining the target query sentence from the plurality of associated query sentences. For example, the target query sentence may be obtained through manners such as a classification model, reinforcement learning, and so on.

As an example, a contextual sentence corresponding to the conversation sentence is obtained, and the contextual sentence is encoded to obtain a contextual sentence vector. A plurality of associated query sentence vectors corresponding to the plurality of associated query sentences is obtained from a preset database. The contextual sentence vector and the plurality of associated query sentence vectors are calculated by a similarity calculation model based on reinforcement learning to obtain relevance scores between the conversation sentence and the plurality of associated query sentences. The target query sentence is determined from the plurality of associated query sentences based on the relevance scores.

As another example, a search vector corresponding to the conversation sentence is obtained. The plurality of associated query sentence vectors corresponding to the plurality of associated query sentences is obtained from the preset database. The search vector is sequentially processed with each of the plurality of associated query sentence vectors through a classification model to obtain a plurality of classification categories corresponding to the conversation sentence and respective associated query sentences. A target category is determined from the plurality of classification categories, and the target query sentence is determined based on the target category.

It should be noted that each query sentence in the preset query word graph is processed in advance through a preset neural network such as a graph neural network, a convolutional neural network, to generate respective query sentence vectors, and the query sentence vectors are stored in the preset database.

With continued reference to FIG. 2, after the plurality of associated query sentences, such as “A Plane Crash of Boeing”, “CEO of Boeing Apologizes” and “A Plane Crash of Boeing 737 in Indonesia”, are determined, “A Plane Crash of Boeing 737 in Indonesia” is obtained as the target query sentence. In order to ensure the fluency of conversation, the obtained target query sentence cannot be directly provided to the user as the response sentence. Instead, the expression of the obtained target query sentence needs to be processed correspondingly through the preset response generation model to generate the response sentence for the user, that is, “CEO of Boeing Apologizes for the Plane Crash of Boeing 737 in Indonesia”.

In summary, according to the human-machine interaction method, the conversation sentence input by the user is obtained. The query sentence matching the conversation sentence is obtained, and the plurality of associated query sentences corresponding to the query sentence is obtained based on the preset query word graph. The conversation sentence and the plurality of associated query sentences are processed through the preset algorithm to select the target query sentence from the plurality of associated query sentences. The target query sentence is processed based on the preset response generation model to generate the response sentence for the user. Consequently, technical problems of insufficient response content in human-machine conversation and an unsatisfying conversation effect are solved, and a high-quality candidate list of response content is provided based on the relevance of query sentences in the query word graph, thereby providing rich content reflecting user interest.

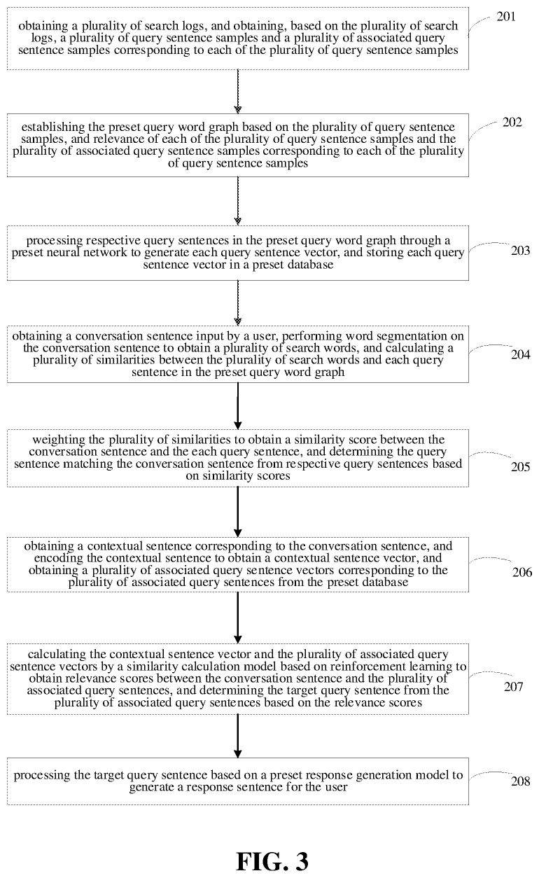

FIG. 3 is a flowchart of a human-machine interaction method according to an embodiment of the disclosure.

At block 201, a plurality of search logs is obtained. A plurality of query sentence samples and a plurality of associated query sentence samples corresponding to each of the plurality of query sentence samples are obtained based on the plurality of search logs.

At block 202, the preset query word graph is established based on the plurality of query sentence samples, and relevance of each of the plurality of query sentence samples and the plurality of associated query sentence samples corresponding to each of the plurality of query sentence samples.

At block 203, respective query sentences in the preset query word graph are processed through a preset neural network to generate each query sentence vector, and each query sentence vector is stored in a preset database.

In detail, according to the disclosure, the query word graph may be established in advance based on the search data. The query word graph may be established in real time based on user identifiers and query sentences within a query period, or relevant data may be directly extracted from the search logs for analysis to establish the query word graph.

In detail, the plurality of search logs is obtained. The plurality of query sentence samples and the plurality of associated query sentence samples corresponding to each of the plurality of query sentence samples are obtained based on the plurality of search logs. The preset query word graph is established based on the plurality of query sentence samples, and relevance of each of the plurality of query sentence samples and the plurality of associated query sentence samples corresponding to each of the plurality of query sentence samples.

For example, it is obtained that the query sentence sample is “Vice President of Boeing Apologizes”, the plurality of associated query sentence samples are “CEO of Boeing Apologizes”, “A Plane Crash of Boeing”, “Chairman of Boeing”, and “A Plane Crash of Boeing 737 in Indonesia”, corresponding to “Vice President of Boeing Apologizes”. The preset query word graph is established based on the query sentence sample “Vice President of Boeing Apologizes”, and the plurality of associated query sentence samples, “CEO of Boeing Apologizes”, “A Plane Crash of Boeing”, “Chairman of Boeing”, and “A Plane Crash of Boeing 737 in Indonesia”.

It may be understood that the above description is only illustrative. The query word graph is established based on the plurality of query sentence samples, and the relevance of each of the plurality of query sentence samples and the plurality of associated query sentence samples corresponding to each of the plurality of query sentence samples. Therefore, the query word graph is established based on the search data. Relevance Queries of respective query sentences in the graph may obtain very accurate answers, such that the conversation effect may be improved.

For processing efficiency, each query sentence in the preset query word graph may be processed in advance through a preset neural network such as a graph neural network, a convolutional neural network, to generate respective query sentence vectors, and the query sentence vectors are stored in the preset database.

At block 204, the conversation sentence input by the user is obtained. Word segmentation is performed on the conversation sentence to obtain a plurality of search words. A plurality of similarities between the plurality of search words and each query sentence in the preset query word graph is calculated.

At block 205, the plurality of similarities is weighted to obtain a similarity score between the conversation sentence and the each query sentence. The query sentence matching the conversation sentence is determined from respective query sentences based on similarity scores.

In detail, the user may interact with the smart device through text or by voice, so that the smart device may obtain the conversation sentence input by the user, such as “I heard that something happened to Boeing recently”, “Huawei P30 is good”, “I usually like to do yoga” and the like. The conversation sentence may be input based on personal characteristics, such as individual needs and expression habits, of users.

Further, the word segmentation is performed on the conversation sentence to obtain the plurality of search words. The plurality of similarities between the plurality of search words and each search sentence in the preset query word graph is calculated. The plurality of similarities is weighted to obtain the similarity score between the conversation sentence and the each query sentence. The query sentence matching the conversation sentence is determined from respective query sentences based on the similarity scores. That is to say, the higher the similarity score, the higher the degree of matching between the query sentence and the conversation sentence, and the more accurate the sentence node mapping the conversation sentence to the query word graph.

At block 206, a contextual sentence corresponding to the conversation sentence is obtained, and the contextual sentence is encoded to obtain a contextual sentence vector. A plurality of associated query sentence vectors corresponding to the plurality of associated query sentences is obtained from the preset database.

At block 207, the contextual sentence vector and the plurality of associated query sentence vectors are calculated by a similarity calculation model based on reinforcement learning to obtain relevance scores between the conversation sentence and the plurality of associated query sentences. The target query sentence is determined from the plurality of associated query sentences based on the relevance scores.

It is understandable that the conversation sentence may not be the sentence inputted in the first time. Consequently, in order to improve the accuracy of response, the contextual sentence corresponding to the conversation sentence is obtained, and the contextual sentence is encoded to obtain the contextual sentence vector. The plurality of associated query sentence vectors corresponding to the plurality of associated query sentences is obtained from the preset database. The contextual sentence vector and the plurality of associated query sentence vectors are calculated by the similarity calculation model based on reinforcement learning to obtain the relevance scores between the conversation sentence and the plurality of associated query sentences. The target query sentence is determined from the plurality of associated query sentences based on the relevance scores.

It may be understood that the higher the relevance score, the stronger the relevance between the conversation sentence and the corresponding associated query sentence, so that the associated query sentence having the highest relevance score may be determined as the target query sentence.

For example, if the conversation sentence is “why did he apologize”, the contextual sentence corresponding to the conversation sentence needs to be obtained for processing. The target query sentence obtained is “A Plane Crash of Boeing 737 in Indonesia”, such that the user need is satisfied, and the conversation effect is improved.

At block 208, the target query sentence is processed based on a preset response generation model to generate a response sentence for the user.

In order to ensure the fluency of conversation, the obtained target query sentence cannot be directly provided to the user as the response sentence. Instead, the expression of the obtained target query sentence needs to be processed correspondingly through the preset response generation model to generate the response sentence for the user, that is, “Because of the Plane Crash of Boeing 737 in Indonesia”.

In summary, according to the human-machine interaction method, the plurality of search logs is obtained. The plurality of query sentence samples and the plurality of associated query sentence samples corresponding to each of the plurality of query sentence samples are obtained based on the plurality of search logs. The preset query word graph is established based on the plurality of query sentence samples, and relevance of each of the plurality of query sentence samples and the plurality of associated query sentence samples corresponding to each of the plurality of query sentence samples. Respective query sentences in the preset query word graph are processed through the preset neural network to generate each query sentence vector, and each query sentence vector is stored in the preset database. The conversation sentence input by the user is obtained. The query sentence corresponding to the conversation sentence is obtained. Word segmentation is performed on the conversation sentence to obtain the plurality of search words. The plurality of similarities between the plurality of search words and each query sentence in the preset query word graph is calculated. The plurality of similarities is weighted to obtain the similarity score between the conversation sentence and the each query sentence. The query sentence matching the conversation sentence is determined from the respective query sentences based on the similarity scores. The contextual sentence corresponding to the conversation sentence is obtained, and the contextual sentence is encoded to obtain the contextual sentence vector. The plurality of associated query sentence vectors corresponding to the plurality of associated query sentences is obtained from the preset database. The contextual sentence vector and the plurality of associated query sentence vectors are calculated by a reinforcement learning algorithm to obtain the relevance scores between the conversation sentence and the plurality of associated query sentences. The target query sentence is determined from the plurality of associated query sentences based on the relevance scores. The target query sentence is processed based on the preset response generation model to generate the response sentence for the user. Consequently, technical problems of insufficient response content in human-machine conversation and an unsatisfying conversation effect are solved, and a high-quality candidate list of response content is provided based on the relevance of query sentences in the query word graph, thereby providing rich content reflecting user interest.

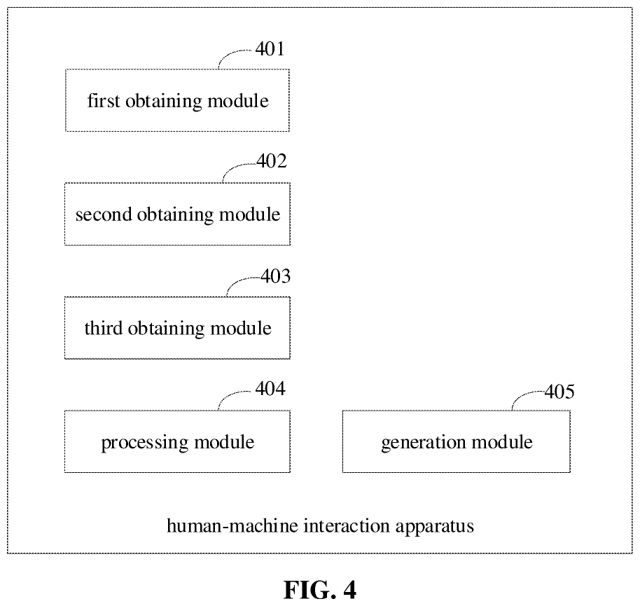

To implement the above embodiments, the disclosure further provides a human-machine interaction apparatus. FIG. 4 is a block diagram of a human-machine interaction apparatus according to an embodiment of the disclosure. As illustrated in FIG. 4, the apparatus includes a first obtaining module 401, a second obtaining module 402, a third obtaining module 403, a processing module 404, and a generation module 405.

The first obtaining module 401 is configured to obtain a conversation sentence input by a user.

The second obtaining module 402 is configured to obtain a query sentence matching the conversation sentence.

The third obtaining module 403 is configured to obtain a plurality of associated query sentences corresponding to the query sentence based on a preset query word graph.

The processing module 404 is configured to process the conversation sentence and the plurality of associated query sentences through a preset algorithm to select a target query sentence from the plurality of associated query sentences.

The generation module 405 is configured to process the target query sentence based on a preset response generation model to generate a response sentence for the user.

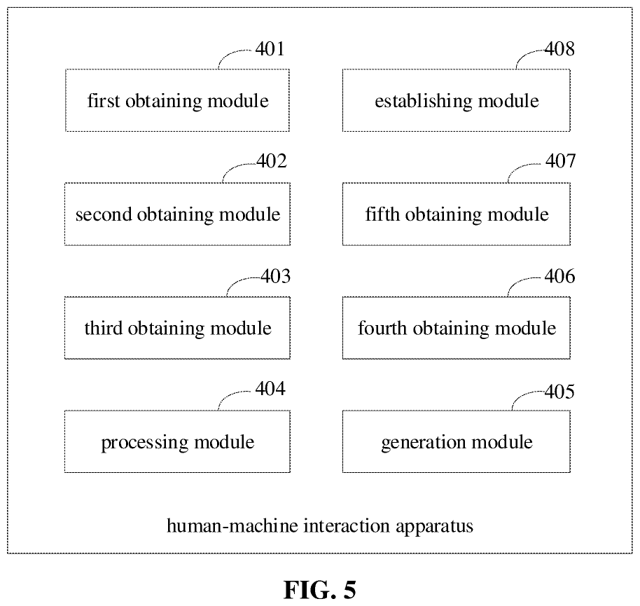

According to an embodiment of the disclosure, as illustrated in FIG. 5 and on the basis of FIG. 4, the apparatus further includes a fourth obtaining module 406, a fifth obtaining module 407, and an establishing module 408.

The fourth obtaining module 406 is configured to obtain a plurality of search logs.

The fifth obtaining module 407 is configured to obtain, based on the plurality of search logs, a plurality of query sentence samples and a plurality of associated query sentence samples corresponding to each of the plurality of query sentence samples.

The establishing module 408 is configured to establish the preset query word graph based on the plurality of query sentence samples, and relevance of each of the plurality of query sentence samples and the plurality of associated query sentence samples corresponding to each of the plurality of query sentence samples.

According to an embodiment of the disclosure, the second obtaining module 402 is configured to: perform word segmentation on the conversation sentence to obtain a plurality of search words; calculate a plurality of similarities between the plurality of search words and each query sentence in the preset query word graph; weight the plurality of similarities to obtain a similarity score between the conversation sentence and the each query sentence; and determine the query sentence matching the conversation sentence from respective query sentences based on similarity scores.

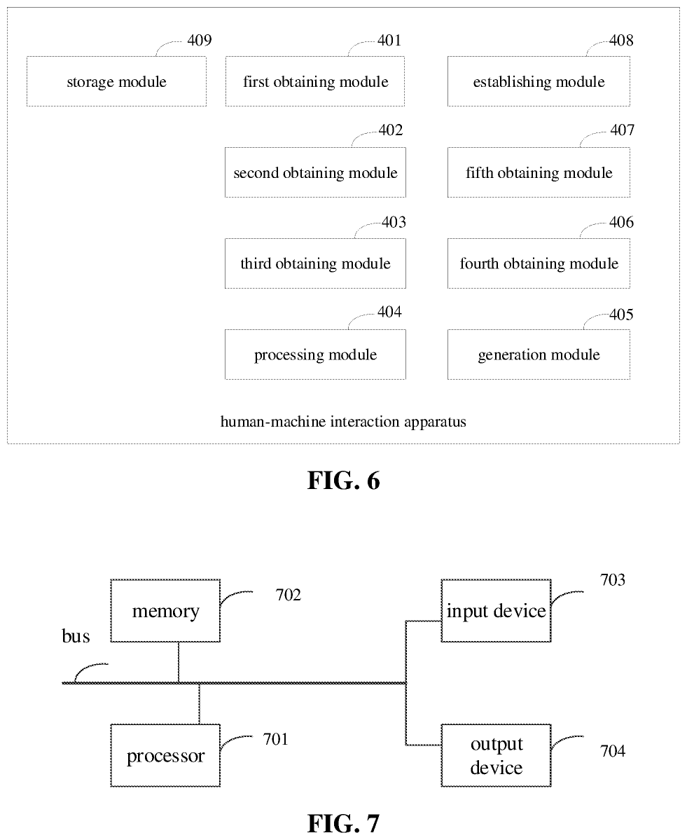

According to an embodiment of the disclosure, as illustrated in FIG. 6 and on the basis of FIG. 5, the apparatus further includes a storage module 409.

The storage module 409 is configured to process respective query sentences in the preset query word graph through a preset neural network to generate each query sentence vector, and to store each query sentence vector in a preset database.

According to an embodiment of the disclosure, the processing module 404 is configured to: obtain a contextual sentence corresponding to the conversation sentence, and encode the contextual sentence to obtain a contextual sentence vector; obtain a plurality of associated query sentence vectors corresponding to the plurality of associated query sentences from the preset database; calculate the contextual sentence vector and the plurality of associated query sentence vectors by a similarity calculation model based on reinforcement learning to obtain relevance scores between the conversation sentence and the plurality of associated query sentences; and determine the target query sentence from the plurality of associated query sentences based on the relevance scores.

It should be noted that the foregoing explanation of the human-machine interaction method is also applicable to the human-machine interaction apparatus according to embodiments of the disclosure. The implementation principles of the apparatus are similar to the implementation principles of the method, and thus details will not be repeated herein.

In summary, according to the human-machine interaction apparatus, the conversation sentence input by the user is obtained. The query sentence matching the conversation sentence is obtained, and the plurality of associated query sentences corresponding to the query sentence is obtained based on the preset query word graph. The conversation sentence and the plurality of associated query sentences are processed through the preset algorithm, and the target query sentence is determined from the plurality of associated query sentences. The target query sentence is processed based on the preset response generation model to generate the response sentence for the user. Consequently, technical problems of insufficient response content in human-machine conversations and an unsatisfying conversation effect are solved, and a high-quality candidate list of response content is provided based on the relevance of query sentences in the query word graph, thereby providing rich content reflecting user interest.

According to embodiments of the disclosure, the disclosure further provides an electronic device and a readable storage medium.

FIG. 7 is a block diagram of an electronic device for implementing a human-machine interaction method according to embodiments of the disclosure. The electronic device is intended to represent various forms of digital computers, such as a laptop computer, a desktop computer, a workbench, a personal digital assistant, a server, a blade server, a mainframe computer and other suitable computers. The electronic device may also represent various forms of mobile devices, such as a personal digital processor, a cellular phone, a smart phone, a wearable device and other similar computing devices. Components shown herein, their connections and relationships as well as their functions are merely examples, and are not intended to limit the implementation of the disclosure described and/or required herein.

As illustrated in FIG. 7, the electronic device includes: one or more processors 701, a memory 702, and interfaces for connecting various components, including a high-speed interface and a low-speed interface. The components are interconnected by different buses and may be mounted on a common motherboard or otherwise installed as required. The processor may process instructions executed within the electronic device, including instructions stored in or on the memory to display graphical information of the GUI on an external input/output device (such as a display device coupled to the interface). In other embodiments, when necessary, multiple processors and/or multiple buses may be used with multiple memories. Similarly, multiple electronic devices may be connected, each providing some of the necessary operations (for example, as a server array, a group of blade servers, or a multiprocessor system). One processor 701 is taken as an example in FIG. 7.

The memory 702 is a non-transitory computer-readable storage medium provided by the disclosure. The memory stores instructions executable by at least one processor, so that the at least one processor executes the method provided by the disclosure. The non-transitory computer-readable storage medium provided by the disclosure stores computer instructions, which are configured to make the computer execute the human-machine interaction method provided by the disclosure.

As a non-transitory computer-readable storage medium, the memory 702 may be configured to store non-transitory software programs, non-transitory computer executable programs and modules, such as program instructions/modules (for example, the first obtaining module 401, the second obtaining module 402, the third obtaining module 403, the processing module 404, and the generation module 405 illustrated in FIG. 4) corresponding to the method for human-machine conversation interaction according to the embodiment of the disclosure. The processor 701 executes various functional applications and performs data processing of the server by running non-transitory software programs, instructions and modules stored in the memory 702, that is, the human-machine interaction method according to the foregoing method embodiments is implemented.

The memory 702 may include a storage program area and a storage data area, where the storage program area may store an operating system and applications required for at least one function; and the storage data area may store data created according to the use of the electronic device, and the like. In addition, the memory 702 may include a high-speed random-access memory, and may further include a non-transitory memory, such as at least one magnetic disk memory, a flash memory device, or other non-transitory solid-state memories. In some embodiments, the memory 702 may optionally include memories remotely disposed with respect to the processor 701, and these remote memories may be connected to the electronic device through a network. Examples of the network include, but are not limited to, the Internet, an intranet, a local area network, a mobile communication network, and combinations thereof.

The electronic device configured to implement the method for human-machine conversation interaction may further include an input device 703 and an output device 704. The processor 701, the memory 702, the input device 703 and the output device 704 may be connected through a bus or in other manners. FIG. 7 is illustrated by establishing the connection through a bus.

The input device 703 may receive input numeric or character information, and generate key signal inputs related to user settings and function control of the electronic device, such as a touch screen, a keypad, a mouse, a trackpad, a touchpad, a pointing stick, one or more mouse buttons, trackballs, joysticks and other input devices. The output device 704 may include a display device, an auxiliary lighting device (for example, an LED), a haptic feedback device (for example, a vibration motor), and so on. The display device may include, but is not limited to, a liquid crystal display (LCD), a light emitting diode (LED) display and a plasma display. In some embodiments, the display device may be a touch screen.

Various implementations of systems and technologies described herein may be implemented in digital electronic circuit systems, integrated circuit systems, application-specific ASICs (application-specific integrated circuits), computer hardware, firmware, software, and/or combinations thereof. These various implementations may include: being implemented in one or more computer programs that are executable and/or interpreted on a programmable system including at least one programmable processor. The programmable processor may be a dedicated or general-purpose programmable processor that may receive data and instructions from a storage system, at least one input device and at least one output device, and transmit the data and instructions to the storage system, the at least one input device and the at least one output device.

These computing programs (also known as programs, software, software applications, or codes) include machine instructions of a programmable processor, and may implement these calculation procedures by utilizing high-level procedures and/or object-oriented programming languages, and/or assembly/machine languages. As used herein, terms “machine-readable medium” and “computer-readable medium” refer to any computer program product, device and/or apparatus configured to provide machine instructions and/or data to a programmable processor (for example, a magnetic disk, an optical disk, a memory and a programmable logic device (PLD)), and includes machine-readable media that receive machine instructions as machine-readable signals. The term “machine-readable signals” refers to any signal used to provide machine instructions and/or data to a programmable processor.

In order to provide interactions with the user, the systems and technologies described herein may be implemented on a computer having: a display device (for example, a cathode ray tube (CRT) or a liquid crystal display (LCD) monitor) for displaying information to the user; and a keyboard and a pointing device (such as a mouse or trackball) through which the user may provide input to the computer. Other kinds of devices may also be used to provide interactions with the user; for example, the feedback provided to the user may be any form of sensory feedback (e.g., visual feedback, auditory feedback or haptic feedback); and input from the user may be received in any form (including acoustic input, voice input or tactile input).

The systems and technologies described herein may be implemented in a computing system that includes back-end components (for example, as a data server), a computing system that includes middleware components (for example, an application server), or a computing system that includes front-end components (for example, a user computer with a graphical user interface or a web browser, through which the user may interact with the implementation of the systems and technologies described herein), or a computing system including any combination of the back-end components, the middleware components or the front-end components. The components of the system may be interconnected by digital data communication (e.g., a communication network) in any form or medium. Examples of the communication network include: a local area network (LAN), a wide area network (WAN), and the Internet.

Computer systems may include a client and a server. The client and server are generally remote from each other and typically interact through the communication network. A client-server relationship is generated by computer programs running on respective computers and having a client-server relationship with each other.

It should be understood that various forms of processes shown above may be reordered, added or deleted. For example, the blocks described in the disclosure may be executed in parallel, sequentially, or in different orders. As long as the desired results of the technical solution disclosed in the disclosure may be achieved, there is no limitation herein.

The foregoing specific implementations do not constitute a limit on the protection scope of the disclosure. It should be understood by those skilled in the art that various modifications, combinations, sub-combinations and substitutions may be made according to design requirements and other factors. Any modification, equivalent replacement and improvement made within the spirit and principle of the disclosure shall be included in the protection scope of the disclosure.

What is claimed is:

1. A human-machine interaction method, comprising:
obtaining a conversation sentence input by a user;
obtaining a query sentence matching the conversation sentence;
obtaining a plurality of associated query sentences corresponding to the query sentence based on a preset query word graph;
processing the conversation sentence and the plurality of associated query sentences through a preset algorithm to select a target query sentence from the plurality of associated query sentences; and
processing the target query sentence based on a preset response generation model to generate a response sentence for the user.

2. The method of claim 1, wherein obtaining the query sentence matching the conversation sentence comprises:
performing word segmentation on the conversation sentence to obtain a plurality of search words;
calculating a plurality of similarities between the plurality of search words and each query sentence in the preset query word graph;
weighting the plurality of similarities to obtain a similarity score between the conversation sentence and the each query sentence; and
determining the query sentence matching the conversation sentence from respective query sentences based on similarity scores.

3. The method of claim 1, further comprising:
obtaining a plurality of search logs;
obtaining, based on the plurality of search logs, a plurality of query sentence samples and a plurality of associated query sentence samples corresponding to each of the plurality of query sentence samples; and
establishing the preset query word graph based on the plurality of query sentence samples, and relevance of each of the plurality of query sentence samples and the plurality of associated query sentence samples corresponding to each of the plurality of query sentence samples.

4. The method of claim 3, further comprising:
processing respective query sentences in the preset query word graph through a preset neural network to generate each query sentence vector, and storing each query sentence vector in a preset database.

5. The method of claim 4, wherein processing the conversation sentence and the plurality of associated query sentences through the preset algorithm to select the target query sentence from the plurality of associated query sentences comprises:
obtaining a contextual sentence corresponding to the conversation sentence, and encoding the contextual sentence to obtain a contextual sentence vector;
obtaining a plurality of associated query sentence vectors corresponding to the plurality of associated query sentences from the preset database;
calculating the contextual sentence vector and the plurality of associated query sentence vectors by a similarity calculation model based on reinforcement learning to obtain relevance scores between the conversation sentence and the plurality of associated query sentences; and
determining the target query sentence from the plurality of associated query sentences based on the relevance scores.

6. The method of claim 4, wherein processing the conversation sentence and the plurality of associated query sentences through the preset algorithm to select the target query sentence from the plurality of associated query sentences comprises:
obtaining a search vector corresponding to the conversation sentence;
obtaining a plurality of associated query sentence vectors corresponding to the plurality of associated query sentences from the preset database;
processing sequentially the search vector with each of the plurality of associated query sentence vectors through a classification model to obtain a plurality of classification categories corresponding to the conversation sentence and respective associated query sentences;
selecting a target category from the plurality of classification categories; and
determining the target query sentence based on the target category.

7. An electronic device, comprising:
at least one processor; and
a storage device communicatively connected to the at least one processor; wherein, the storage device stores an instruction executable by the at least one processor, and when the instruction is executed by the at least one processor, the at least one processor is caused to execute a human-machine interaction method, the method comprising:
obtaining a conversation sentence input by a user;
obtaining a query sentence matching the conversation sentence;
obtaining a plurality of associated query sentences corresponding to the query sentence based on a preset query word graph;
processing the conversation sentence and the plurality of associated query sentences through a preset algorithm to select a target query sentence from the plurality of associated query sentences; and
processing the target query sentence based on a preset response generation model to generate a response sentence for the user.

8. The electronic device of claim 7, wherein obtaining the query sentence matching the conversation sentence comprises:
performing word segmentation on the conversation sentence to obtain a plurality of search words;
calculating a plurality of similarities between the plurality of search words and each query sentence in the preset query word graph;
weighting the plurality of similarities to obtain a similarity score between the conversation sentence and the each query sentence; and
determining the query sentence matching the conversation sentence from respective query sentences based on similarity scores.

9. The electronic device of claim 7, wherein the method further comprises:
obtaining a plurality of search logs;
obtaining, based on the plurality of search logs, a plurality of query sentence samples and a plurality of associated query sentence samples corresponding to each of the plurality of query sentence samples; and
establishing the preset query word graph based on the plurality of query sentence samples, and relevance of each of the plurality of query sentence samples and the plurality of associated query sentence samples corresponding to each of the plurality of query sentence samples.

10. The electronic device of claim 9, wherein the method further comprises:
processing respective query sentences in the preset query word graph through a preset neural network to generate each query sentence vector, and storing each query sentence vector in a preset database.

11. The electronic device of claim 10, wherein processing the conversation sentence and the plurality of associated query sentences through the preset algorithm to select the target query sentence from the plurality of associated query sentences comprises:
obtaining a contextual sentence corresponding to the conversation sentence, and encoding the contextual sentence to obtain a contextual sentence vector;
obtaining a plurality of associated query sentence vectors corresponding to the plurality of associated query sentences from the preset database;
calculating the contextual sentence vector and the plurality of associated query sentence vectors by a similarity calculation model based on reinforcement learning to obtain relevance scores between the conversation sentence and the plurality of associated query sentences; and
determining the target query sentence from the plurality of associated query sentences based on the relevance scores.

12. The electronic device of claim 10, wherein processing the conversation sentence and the plurality of associated query sentences through the preset algorithm to select the target query sentence from the plurality of associated query sentences comprises:
obtaining a search vector corresponding to the conversation sentence;
obtaining a plurality of associated query sentence vectors corresponding to the plurality of associated query sentences from the preset database;
processing sequentially the search vector with each of the plurality of associated query sentence vectors through a classification model to obtain a plurality of classification categories corresponding to the conversation sentence and respective associated query sentences;
selecting a target category from the plurality of classification categories; and
determining the target query sentence based on the target category.

13. A non-transitory computer-readable storage medium having a computer instruction stored thereon, wherein the computer instruction is configured to cause a computer to execute a human-machine interaction method, the method comprising:
obtaining a conversation sentence input by a user;
obtaining a query sentence matching the conversation sentence;
obtaining a plurality of associated query sentences corresponding to the query sentence based on a preset query word graph;
processing the conversation sentence and the plurality of associated query sentences through a preset algorithm to select a target query sentence from the plurality of associated query sentences; and
processing the target query sentence based on a preset response generation model to generate a response sentence for the user.

14. The non-transitory computer-readable storage medium of claim 13, wherein obtaining the query sentence matching the conversation sentence comprises:
performing word segmentation on the conversation sentence to obtain a plurality of search words;
calculating a plurality of similarities between the plurality of search words and each query sentence in the preset query word graph;
weighting the plurality of similarities to obtain a similarity score between the conversation sentence and the each query sentence; and
determining the query sentence matching the conversation sentence from respective query sentences based on similarity scores.

15. The non-transitory computer-readable storage medium of claim 13, wherein the method further comprises:
obtaining a plurality of search logs;
obtaining, based on the plurality of search logs, a plurality of query sentence samples and a plurality of associated query sentence samples corresponding to each of the plurality of query sentence samples; and
establishing the preset query word graph based on the plurality of query sentence samples, and relevance of each of the plurality of query sentence samples and the plurality of associated query sentence samples corresponding to each of the plurality of query sentence samples.

16. The non-transitory computer-readable storage medium of claim 15, wherein the method further comprises:
processing respective query sentences in the preset query word graph through a preset neural network to generate each query sentence vector, and storing each query sentence vector in a preset database.

17. The non-transitory computer-readable storage medium of claim 16, wherein processing the conversation sentence and the plurality of associated query sentences through the preset algorithm to select the target query sentence from the plurality of associated query sentences comprises:
obtaining a contextual sentence corresponding to the conversation sentence, and encoding the contextual sentence to obtain a contextual sentence vector;
obtaining a plurality of associated query sentence vectors corresponding to the plurality of associated query sentences from the preset database;
calculating the contextual sentence vector and the plurality of associated query sentence vectors by a similarity calculation model based on reinforcement learning to obtain relevance scores between the conversation sentence and the plurality of associated query sentences; and
determining the target query sentence from the plurality of associated query sentences based on the relevance scores.

18. The non-transitory computer-readable storage medium of claim 16, wherein processing the conversation sentence and the plurality of associated query sentences through the preset algorithm to select the target query sentence from the plurality of associated query sentences comprises:
obtaining a search vector corresponding to the conversation sentence;
obtaining a plurality of associated query sentence vectors corresponding to the plurality of associated query sentences from the preset database;
processing sequentially the search vector with each of the plurality of associated query sentence vectors through a classification model to obtain a plurality of classification categories corresponding to the conversation sentence and respective associated query sentences;
selecting a target category from the plurality of classification categories; and
determining the target query sentence based on the target category.
